(19) United States
(12) Patent Application Publication
(10) Pub. No.: US 2008/0273477 A1
(43) Pub. Date: Nov. 6, 2008

(54) Method and Apparatus for Streaming Audio Data Across a VOIP Gateway to Digital Handsets

(75) Inventors: Christopher J. Cotignola, Doylestown, PA (US); Louis V. Donofrio, Harleysville, PA (US); Dipak R. Patel, Hatboro, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/743,972

(22) Filed: May 3, 2007

(51) Int. Cl. H04L 12/16

(52) U.S. Cl. 370/271

(57) ABSTRACT

A VoIP telephone system which enables a user to receive and play audio files, such as music, over a telephone handset. The telephone system uses a media terminal adaptor (MTA) to provide voice communications to a telephone base station which communicate with a plurality of telephone handsets. The MTA stores a plurality of audio files which may be streamed to the handsets via the base station to be played back to the users. The audio files may be retrieved from a PC connected to the MTA or downloaded from a server through the IP network.

### FIELD OF INVENTION

This application relates to a method and apparatus for streaming audio across a VoIP gateway to digital handsets.

### BACKGROUND

The use of voice services provided over Internet protocols (VoIP) is widespread and an increasingly popular alternative to standard telephone services. A typical VoIP service is provided through a broadband connection to the internet, such as a cable modem or DSL modem contained in a media terminal adapter (MTA). The MTA typically connects to a conventional telephone and serves as an interface between the conventional telephone and the VoIP services.

Conventional telephones are often a combination of a base station with one or more wireless handsets. The base station may be connected to a MTA and wirelessly communicate with the handsets. In this manner, VoIP services are provided to handsets through the base station and the MTA. However, conventional VoIP services simply enable voice communications to be provided to a user.

### SUMMARY

The invention allows a user to listen to streamed audio through a telephone handset. The invention allows a user to listen to audio files, such as music in any room of the house by simply moving a handset. A telephone system with multiple handsets can also be provided with multiple music streams at the same time. The VoIP service providers can provide the audio files to the user as an additional service as well.

In accordance with the principles of the invention, an apparatus for providing data to handsets may comprise: a media terminal adaptor, such as an embedded multimedia terminal adaptor (eMTA) configured to provide voice communications between an IP network and a telephone system and being configured to receive audio data; and a telephone base station configured to communicate with the media terminal adaptor and at least one telephone handset, wherein the telephone base station is configured to receive audio data from the media terminal adaptor and to provide the audio data to the at least one handset. In the apparatus, the media terminal adapter may include a processor and a memory, and the processor may receive requests from a handset for audio data. The processor may provide a menu of available audio data for selection by a user to be provided to a handset. The processor, may receive a selection of a particular audio data file from a user and provide the particular audio data file to the user. The processor may access a service through the IP network to obtain audio data files to be provided to a handset. In the apparatus, the processor may receive access instructions from a handset and provide the audio data to the handset in a continuous stream to be played by the handset to a user. The access instructions include one of: play, pause, stop, rewind and fast forward.

In accordance with the principles of the invention, a method of providing data to handsets may comprise the steps of: receiving a request for an audio file from a telephone handset; receiving a selection of a specific audio file from a handset; and providing the specific audio file from a media terminal adaptor to the handset, the media terminal adaptor being configured to provide voice communications with the telephone handset and an IP network. The method may include, prior to the step of receiving a selection of a specific audio file, a step of providing a menu of available audio files stored on the media terminal adaptor to the handset. The method may also include, prior to the step of providing the specific audio file, the step of requesting a specific audio file from a server through the IP network. The step of requesting a specific audio file from a server may further comprise receiving a listing of audio files for download from the server and providing the listing to a handset. In the method, the step of providing the specific audio file may include receiving access instructions from a handset and providing the specific audio file to the handset in a continuous stream to be played by the handset to a user. The access instructions may include one of: play, pause, stop, rewind and fast forward.

In accordance with the principles of the invention, a computer readable medium carrying a method of providing data to handsets to be performed by a processor may comprise the steps of: receiving a request for an audio file from a telephone handset; receiving a selection of a specific audio file from a handset; and providing the specific audio file from a media terminal adaptor to the handset, the media terminal adaptor being configured to provide voice communications with the telephone handset and an IP network. The instructions may include, prior to the step of receiving a selection of a specific audio file, a step of providing a menu of available audio files stored on the media terminal adaptor to the handset. The instructions may also include, prior to the step of providing the specific audio file, the step of requesting a specific audio file from a server through the IP network.

### BRIEF DESCRIPTION OF THE DRAWINGS

FIG. 1 illustrates an exemplary network arrangement in accordance with the invention,

FIG. 2 illustrates an exemplary MTA and base station arrangement in accordance with the invention.

FIG. 3 illustrates an exemplary handset arrangement in accordance with the invention

FIG. 4 illustrates an exemplary menu of a handset in accordance with the invention.

FIG. 5 illustrates an exemplary process flow in accordance with the invention

### DETAILED DESCRIPTION

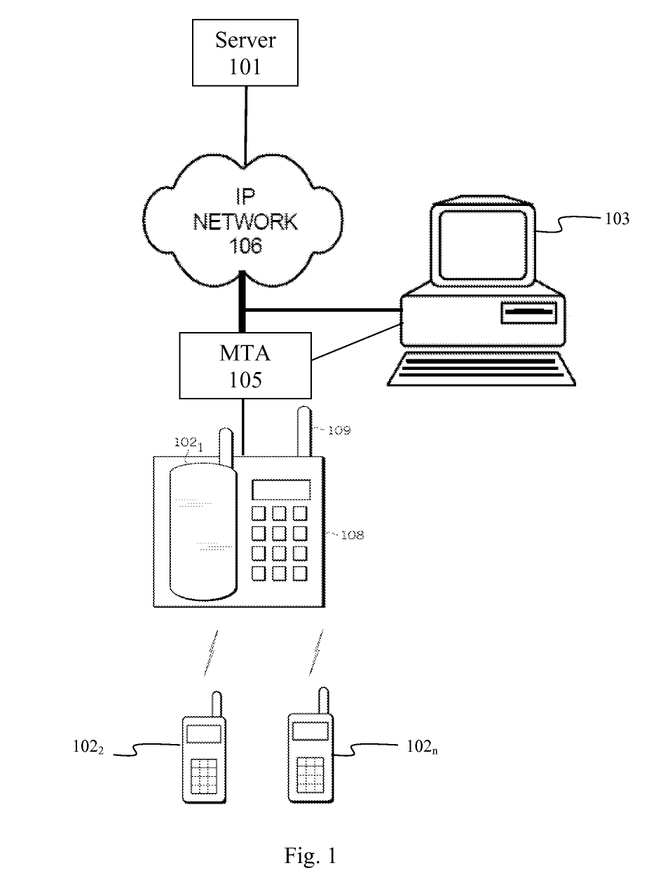

FIG. 1 illustrates an exemplary network arrangement in accordance with the invention. As illustrated in FIG. 1, a MTA 105 is connected to an IP network 106, such as through a coaxial cable or optical fiber network, e.g. an HFC (hybrid fiber coaxial) network. Computer 103 may also be connected to the IP network through MTA 100 or through another connection. Base station 108 is connected to MTA 105, or may be integrally formed with MTA 105 Base station 108 preferably is a wireless telephone and may communicate with several handsets 102₁, 102₂ through 102ₙ. Server 101 is also connected to the IP network 106 and provides audio data, such as music files which may be down loaded by MTA 105 at the request of a user through a handset 102.

The IP network 106 may include the Internet or other public and private networks. The IP network 106 may be connected to any number of telephone systems and computing systems, including a server 101. The server 101 may be any computing device capable of communicating with the IP network 106 and having an IP application host. For example, the server 101 may be a network server hosting a website or a music subscription service. Therefore, a user may access the IP application host by interfacing with the IP application on the handset 102.

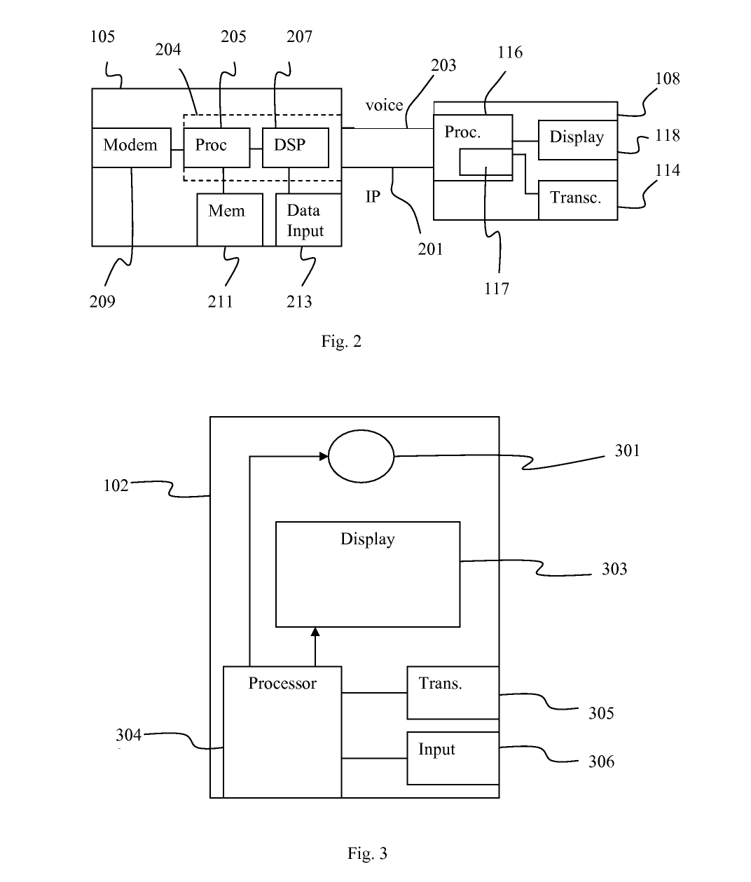

FIG. 2 illustrates an exemplary MTA and base station arrangement in accordance with the invention. As illustrated in FIG. 2, MTA 105 may contain a modem 209 which provides communication with the IP network. Modem 209 may be integrally formed with the MTA or may be a separate component from MTA 105. Processing unit 204 provides communications to and from modem 209. Processing unit 204 preferably contains a processor 205 and a digital signal processor (DSP) 207 Processor 205 and DSP 207 may be separate components or integrally formed in the same unit, and are merely illustrated as separate components for discussion purposes. Processing unit also preferably contains a codec (decoder/encoder), such as an MPEG codec which may be integrated with DSP 207. Those of skill in the art will appreciate that processing unit may also include a SLIC to provide voice communications to base station 108.

Memory 211 preferably contains a ROM which is capable of storing instructions to be performed by processing unit 204. Memory 211 also preferably contains a RAM which is capable of storing data from processing unit 204 and providing the stored data to processing unit 204. A data input 213 is preferably capable of providing input to processing unit 204. Data input 213 may include a USB port and may receive data from a personal computer or a user input device, such as a keyboard or mouse.

Voice data may be provided between base station 108 and MTA 105 through a voice communication line 203. IP data may be provided between base station 108 and MTA 105 through a IP data line 201. While illustrated as separate communication lines, those of skill in the art will appreciate that voice line 203 and IP data line 201 may be on the same communication line. Also, wireless communications may be used between MTA 105 and base station 108 to provide the voice and/or IP data communications. The voice data and IP data may be provided simultaneously.

Base station 108 preferably contains a processing unit 116 which receives communications from processing unit 204 of MTA 105 through inputs and outputs (not shown). Processing unit 116 preferably prepares communications from MTA 105 for wireless transmission to the handsets via transceiver 114. Processing unit 116 also receives communications from the handsets via transceiver 114. Base station 108 may also include a display 118 which may display information related to the communications, such as the identity or number of a calling party, or the name of a song being transmitted to a handset. Those of skill in the art will appreciate that various menu, control and setting information may be displayed as well.

The base station 108 may be similar to base stations used in conventional cordless telephones, however, the base station 108 also includes, at least, a routing module 117 associated with processor 116. The routing module 117 may be hardware, software, or a combination of hardware and software for distinguishing between, and routing, different types of data. For instance, the routing module 117 may distinguish between the voice data and the IP data received from the handset 102.

FIG. 3 illustrates an exemplary handset 102 in accordance with the invention Handset 102 preferably contains a processor 304 which receives and sends communications from/to base station 108 through transceiver 305. Processor 304 also receives user input through input 306, which preferably includes a keypad to allow a user to dial a phone number. A display 303 may also display information to a user from processor 304. The displayed information may include information related to the communications, such as the identity or number of a calling or called party. The displayed information may also include a website or a menu from which songs titles may be selected, and playback of the songs may be controlled. A speaker 301 is also preferably contained on handset 102 which provides the audio of a communication or a song to the user. A microphone is also preferably contained on the handset to provide communications from the user to other telephone users via the IP network. Handset 102 may also contain an output to provide the audio of communications to other devices, such as headphones or a stereo.

As set forth above, the handset 102 may send/receive data to/from the base station 108. The wireless communications may utilize radio frequency (RF) signals, such as DECT 6.0 protocol, for communications between the base station 108 and the handset 102, to transmit voice and data to/from the base station to/from the handset(s), hence providing a cordless telephone system. Alternatively, or in addition thereto, other forms of wireless communication, such as infrared (IR) may be used. In an embodiment, the handset 102 may have the ability to connect directly to the base station 108 via a wire, cable, cord, etc., or by direct physical contact between the handset 102 and the base station 108. For example, the base station 108 may be configured to act as a “cradle” to receive and provide power to the handset 102. When connected to the base station 108 in the manner described in this example, the handset 102 may send and receive both voice data and IP data to/from the base station 108.

While FIG. 2 illustrates MTA 105 and base station 108 as separate devices for discussion purposes, those of skill in the art will appreciate that they may be formed as a single device, such as an embedded MTA (eMTA), and may be an eMTA in a preferred implementation. The base station 108 and the MTA 105 may be separate components and may communicate with each other via a wire, such as through a universal serial bus (USB) connection, pulse code modulation/time division multiplex (PCM/TDM) interface coupled with a universal asynchronous receiver/transmitter (UART), 10/100 Ethernet, RF-11 ports, etc., or wirelessly, through RF signals, etc. The base station 108, the MTA 105, and the modem 209 may also be separate and distinct components, or they may be combined in any combination. For example, the MTA 105 may be integrated with the base station 108, while the modem 209 is a separate and distinct piece of hardware. However, in another embodiment, the base station 108 and the MTA 105 may be a single integrated component and may, therefore, communicate along a common bus. Whether the base station 108 and the components of the MTA 105 are separated or integrated, the format of the voice data may be common between both the base station 108 and the MTA 105. For example, the format of the voice data 203 may be 16-bit lineal PCM.

The base station 108 and the MTA 105 may transmit and receive both voice data and audio data, such as IP data, simultaneously therebetween. Similarly, the handset 102 and the base station 108 may also transmit and receive both voice data and audio data simultaneously therebetween. Therefore, when the handset 102 is transmitting or receiving voice data, another handset 102 may also transmit or receive audio data.

Alternatively, the base station 108, the MTA 105 and the handset 102, respectively, may transmit and receive both voice data and audio data separately and independently from the other form of data. The audio data may be sent and received without first establishing a telephone call for the transmission of voice data. In this sense, the telephone system is always “on.” That is, a user may send and receive audio data, such as an audio file (e.g. MP3 file), through the audio application without being connected to another user via a telephone call. In this embodiment, a user needs only to log onto the audio application, such as a website application, a subscription application or an instant messenger application, using the handset 102 to transmit or receive the audio data. The audio data may be stored at the MTA 105 and streamed to the base station 108 and transmitted to the handset 102. Alternatively, the audio data may be stored at the base station 108 and streamed to the handset via wireless transmission. If the handset 102 contained sufficient memory, the audio data may be stored at the handset.

As set forth above, the telephone system may include more than one handset 102. In this embodiment, each handset 102 may independently and concurrently access the IP network 106 in the manner described above. That is, each handset 102 may have its own path to the IP network 106. Moreover, each handset 102 may send and receive both voice data and audio data to/from the other handsets. The handsets may communicate with each other in different manners. For example, the handset 102 may utilize its path through the IP network 106 to send audio data out to the IP network 106 to, for example, the server 101 running the IP application host. The server 101 may then transmit the audio data back through the IP network 106 to the MTA 105 and, ultimately, to another handset operating on the base station 108.

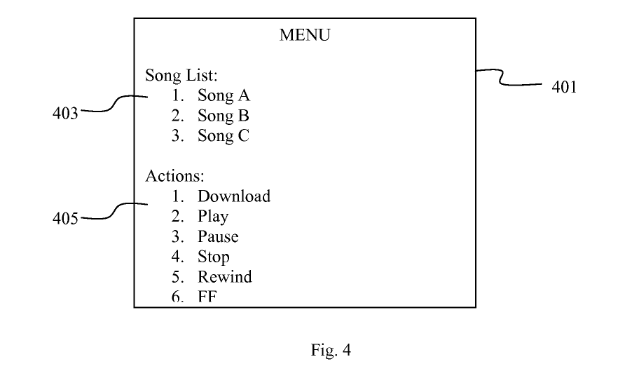

FIG. 4 illustrates an exemplary menu 401 which may be displayed on handset 102. As illustrated, a display of available songs titles 403 which may be retrieved, such as from server 102, may be provided. Other information may be displayed as well, such as artist name, type of music or genre, etc. A list of actions 405 which the user may take may also be displayed, which may include downloading the song and playback instructions for the song, e.g. play, stop, pause, rewind, and fast forward.

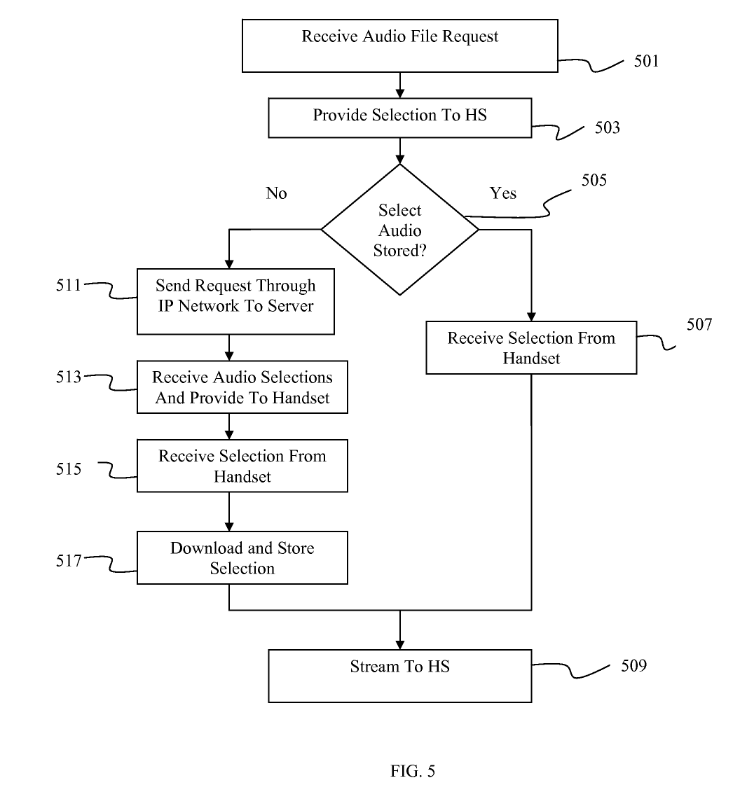

FIG. 5 illustrates an exemplary process for providing audio data, such as music, to the handsets 102. As illustrated in FIG. 5, MTA 105 receives a request for an audio file, step 501. MTA 105 provides a list of audio files for selection to the handset in step 503, via base station 108, of available audio files stored on MTA 105 or stored on a PC connected to MTA 105. The list of audio files may be displayed on the handset 102 as described in connection with FIG. 4. If the user desires to access a stored audio file, step 505, Yes, the MTA 105 receives the user selection from handset 102, step 507. The user may make the selection by pressing a number on a keypad of handset 102 which is displayed as being associated with an audio file. The selected audio file is preferably streamed to the handset 102 via base station 108, step 509. The process of streaming the audio file may begin when the user, selects a “play” option, and may be paused, stopped, rewound or fast forwarded when the user selects any of those corresponding options on the handset.

If the user does not select a stored audio file, step 505, No, then the request may be provided to server 101 through IP network 106, step 511. Server 101 may provide an interactive website or other listing of available audio files for download. The web page associated with the website, or other menu page, may be displayed on handset 102 via MTA 105 and base station 108, step 513. The user may make a selection of a desired audio file by pressing a number key associated with a displayed audio file listing. Once the selection is received by MTA 105, step 515, the selected audio file may be downloaded to MTA 105 and stored, step 517. The audio file may streamed to the handset 102, step 509. The process of streaming the audio file may begin when the user selects a “play” option, and may be paused, stopped, rewound or fast forwarded when the user selects any of those corresponding options on the handset.

Server 101 may also require a billing arrangement with the user, such as a subscription service or a fee based on each download. The user may be billed based on providing a credit card to subscription service 101 or based on the user's telephone number or billing information associated with the user's telephone service. The communications to server 101, including the downloaded audio file may be encrypted to prevent piracy. The communications between the handset 102 and the base station 108 and MTA 105 may also be encrypted. The downloaded audio files may also be provided with limited use restrictions, such as one time play or one week use rules.

One or more of the steps of the process described in and in conjunction with FIG. 5 and other steps described herein may be implemented as software embedded or stored on a computer readable medium, such as the memory 211 shown in FIG. 2 or other storage. The steps may be embodied by a computer program, which may exist in a variety of forms both active and inactive. For example, they may exist as software program(s) comprised of program instructions in source code, object code, executable code or other formats for performing some of the steps when executed. Modules include software, such as programs, subroutines, objects, etc. Any of the above may be stored on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

The invention provides additional features and functionality to a user's telephone system by allowing a user to listen to audio files, such as music in any room of the house by simply moving a handset. A telephone system with multiple handsets can also be provided with multiple music streams at the same time. The telephone service providers can provide the audio files to the user as an additional service as well.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. An apparatus for providing data to handsets comprising;
a media terminal adaptor configured to provide voice communications between an IP network and a telephone system and being configured to receive audio data; and
a telephone base station configured to communicate with the media terminal adaptor and at least one telephone handset,
wherein the telephone base station is configured to receive audio data from the media terminal adaptor and to provide the audio data to the at least one handset.

2. The apparatus of claim 1, wherein the media terminal adapter includes a processor and a memory, and the processor receives requests from a handset for audio data.

3. The apparatus of claim 2, wherein the processor provides a menu of available audio data for selection by a user to be provided to a handset.

4. The apparatus of claim 3, wherein the processor receives a selection of a particular audio data file from a user and provides the particular audio data file to the user.

5. The apparatus of claim 2, wherein the processor accesses a service through the IP network to obtain audio data files to be provided to a handset.

6. The apparatus of claim 2, wherein the processor receives access instructions from a handset and provides the audio data to the handset in a continuous stream to be played by the handset to a user.

7. The apparatus of claim 6, wherein the access instructions include one of: play, pause, stop, rewind and fast forward.

8. A method of providing data to handsets comprising the steps of.:
receiving a request for an audio file from a telephone handset;
receiving a selection of a specific audio file from a handset; and
providing the specific audio file from a media terminal adaptor to the handset, the media terminal adaptor being configured to provide voice communications with the telephone handset and an IP network.

9. The method of claim 8, further comprising, prior to the step of receiving a selection of a specific audio file, a step of providing a menu of available audio files stored on the media terminal adaptor to the handset.

10. The method of claim 8, further comprising, prior to the step of providing the specific audio file, the step of requesting a specific audio file from a server through the IP network.

11. The method of claim 10, wherein the step of requesting a specific audio file from a server further comprises receiving a listing of audio files for download from the server and providing the listing to a handset.

12. The method of claim 8, wherein the step of providing the specific audio file includes receiving access instructions from a handset and providing the specific audio file to the handset in a continuous stream to be played by the handset to a user.

13. The method of claim 12, wherein the access instructions include one of play, pause, stop, rewind and fast forward.

14. A computer readable medium carrying a method of providing data to handsets to be performed by a processor comprising the steps of:
receiving a request for an audio file from a telephone handset;
receiving a selection of a specific audio file from a handset; and
providing the specific audio file from a media terminal adaptor to the handset, the media terminal adaptor being configured to provide voice communications with the telephone handset and an IP network.

15. The computer readable medium of claim 14, further comprising instructions for, prior to the step of receiving a selection of a specific audio file, a step of providing a menu of available audio files stored on the media terminal adaptor to the handset.

16. The computer readable medium of claim 14, further comprising instructions for, prior to the step of providing the specific audio file, the step of requesting a specific audio file from a server through the IP network.

17. The computer readable medium of claim 16, wherein the step of requesting a specific audio file from a server further comprises receiving a listing of audio files for download from the server and providing the listing to a handset.

18. The method of claim 14, wherein the step of providing the specific audio file includes receiving access instructions from a handset and providing the specific audio file to the handset in a continuous stream to be played by the handset to a user.

19. The method of claim 18, wherein the access instructions include one of: play, pause, stop, rewind and fast forward.
